(19) United States
(12) Patent Application Publication
(10) Pub. No.: US 2017/0122483 A1
(43) Pub. Date: May 4, 2017

(54) TUBE LINER WITH A FLEECE-LAMINATED FILM WEB CONNECTED TO FORM A FILM TUBE

(71) Applicant: BKP Berolina Polyester GmbH & Co. KG, Velten (DE)

(72) Inventor: Ralf Odenwald, Velten (DE)

(21) Appl. No.: 15/406,756

(22) Filed: Jan. 15, 2017

Related U.S. Application Data
(63) Continuation of application No. PCT/EP2015/066138, filed on Jul. 15, 2015.

(30) Foreign Application Priority Data
Jul. 18, 2014 (DE) 10 2014 214 029.3

(51) Int. Cl. F16L 55/165; B29C 65/08; B32B 7/12; B32B 1/08; B32B 5/02; B32B 5/26; B29C 63/34; B29C 65/18

(52) U.S. Cl. CPC F16L 55/1656; B29C 63/34; B29C 65/08; B29C 65/18; B32B 1/08; B32B 5/022; B32B 5/26; B32B 7/12; B32B 2250/44; B32B 2260/023; B32B 2260/046; B32B 2307/412

(57) ABSTRACT

A tube liner for lining pipelines includes an inner film tube, an outer film tube, and an interdisposed layer of fiber material which is impregnated with a curable material. At least one of the two film tubes are formed by at least one tube web which includes a carrier film and a fleece layer which is applied to the film side of the carrier film that is facing the layer of fiber material. The web edges of the carrier film that overlap one another in the circumferential direction of the tube are connected to one another. The web edge that in the overlap region is facing away from the layer of fiber material is formed singularly by the carrier film which in the overlap region protrudes beyond the fleece layer and which is adhesively bonded or welded directly to the carrier film of the web edge that in the overlap region is facing the layer of fiber material.

### CROSS-REFERENCE TO RELATED APPLICATIONS

This continuation application claims priority to PCT/EP2015/066138 filed on Jul. 15, 2015 which has published as WO 2016/008914 A1 and also the German Patent Application No. 10 2014 214 029.3, filed on Jul. 18, 2014, the entire contents of which are fully incorporated herein with these references.

### DESCRIPTION

Field of the Invention

The invention relates to a tube liner for lining pipelines, comprising an inner film tube, an outer film tube, and an interdisposed layer of fiber material impregnated with a curable material, wherein at least one of the two film tubes is formed by at least one tube web which comprises a carrier film and a fleece layer which is applied to the film side of the carrier film that is facing the layer of fiber material, and the web edges of which that overlap one another in the circumferential direction of the tube are connected to one another.

Background

A tube liner of this type has been made known by DE 10 201 2 015 047 A1, for example.

Damaged pipelines that are not accessible on foot are rehabilitated by way of so-called relining methods, wherein a new pipe is produced on site from curable molding compounds. To this end, a carrier or reinforcement material (tube liner) that is soaked with curable plastics is introduced into an old pipe to be rehabilitated, wherein light-curing resins are often used as the curable plastics. In the case of light-curing resins, the introduced tube liner is positioned and is pressed against the inner wall of the old pipe by compressed air, and one or a plurality of radiators, in particular UV radiators, are thereafter moved through the tube liner in order for the tube liner to be cured by means of the emitted radiation from the inside.

The tube liner that is known from DE 10 2012 015 047 A1 comprises an inner film tube and a layer of fiber material that is disposed on the inner film tube and soaked with a reactive resin that is curable by UV light. The inner film tube contains a styrene-tight and thermally weldable carrier material which has a laminated fleece layer on the side that is facing the fibrous material and which comprises an overlap region that extends along the inner film tube in which overlap region the edge portions of the carrier material are thermally welded to one another. On the outer side of the radially inboard edge portion, the fleece layer in the overlap region is thermally welded to the carrier material on the lower side of the radially outboard edge portion, wherein the radially outboard edge portion on the outer side thereof in the overlap region has a structure which enables a reactive resin to durably adhere thereto. The fleece material that in the overlap region lies between a PE layer of the radially outboard edge portion and a PE layer of the radially inboard edge portion is heated by ultrasonic energy so far until the thermoelastic plastics material of the PE layer melts, liquefies, and penetrates the fleece material. After cooling, a thermally welded air-tight connection of high strength is obtained between the two edge portions.

As opposed thereto, it is the object of the invention to refine a tube liner of the type mentioned at the outset in such a manner that the film ends are better interconnected while simultaneously providing lower technical complexity.

### SUMMARY OF THE INVENTION

This object is achieved according to the invention in that the web edge that in the overlap region is facing away from the layer of fiber material is formed singularly by the carrier film which in the overlap region protrudes beyond the fleece layer and which is adhesively bonded or welded directly to the carrier film of the web edge that in the overlap region is facing the layer of fiber material.

According to the invention, the carrier films of the two overlapping web edges are directly interconnected, wherein the film side that is facing the layer of fiber material is nevertheless covered all-over by the fleece layer. The web edges of the carrier film(s) that bear on top of one another in the overlap region are adhesively bonded or welded to one another in the longitudinal direction of the tube, wherein all known film-welding methods, that is to say, for example, ultrasonic welding or thermal welding (“hot-tool welding”), may be employed for welding. The tube liner according to the invention may have light-curing resins or else other curable materials such as, for example, materials that are cured by cold curing, or materials that are cured by heat and that are cured by hot water or steam by which the tube liner is impinged.

Particularly advantageously, both the inner film tube as well as the outer film tube each are formed by at least one tube web which has a carrier film and a fleece layer which is applied to the film side of the carrier film that is facing the layer of fiber material, and the web edges of which that overlap one another in the circumferential direction of the tube are connected to one another, wherein the web edges that in the overlap region are facing away from the layer of fiber material each are formed singularly by the carrier film which in the overlap region projects beyond the fleece layer and which is adhesively bonded or welded directly to the carrier film of the web edge that in the overlap region is facing the layer of fiber material.

Preferably, the carrier film and the laminated fleece layer terminate so as to be mutually flush on the web edge that is facing the layer of fiber material in the overlap region.

The film tube may be formed by one or by a plurality of tube webs (flat films). The latter case is advantageous in particular when a film tube that exceeds the maximum width of an available flat film is to be produced. In one variant of this embodiment, the tube webs each have a flush web edge that is fleece-laminated, as well as a projecting carrier film edge that is free from fleece material. In another variant, the one tube web has two flush web edges that are fleece-laminated, and the other tube web has projecting carrier film edges that are free from a fleece material.

The side of the welded film tube that is facing the layer of fiber material is covered all-over by the fleece layer, wherein the fleece layers of the two web edges may abut one another. Alternatively, the web edge on which the carrier film and the fleece layer terminate so as to be mutually flush may protrude somewhat beyond the other web edge that is free from a fleece material.

The carrier film may be formed by a single film layer or by a composite film having a plurality of film layers. In the latter case, the two outer film layers are preferably composed of the same material since they are then more readily weldable or adhesively bondable to one another.

Further advantages and advantageous embodiments of the subject matter of the invention may be derived from the description, from the drawing, and from the claims. According to the invention, the features that have been mentioned above and that will furthermore be listed may likewise each be used individually or in any arbitrary combination. The embodiments shown and described are not to be understood as being a final enumeration but rather have an exemplary character in order for the invention to be presented.

### BRIEF DESCRIPTION OF DRAWINGS

FIGS. 1a, 1b show the cross section (FIG. 1a) of a first embodiment of the tube liner according to the invention, having an inner film tube which is formed by a welded tube web, and the tube web in the still unwelded state (FIG. 1b);

FIGS. 2a, 2b show the cross section (FIG. 2a) of an inner film tube that is formed from two welded-together tube webs, in a second embodiment of the tube liner according to the invention, and the two tube webs in the still unwelded state (FIG. 2b);

FIGS. 3a, 3b show the cross section (FIG. 3a) of an inner film tube that is formed from two welded-together tube webs, in a third embodiment of the tube liner according to the invention, and the two tube webs in the still unwelded state (FIG. 3b);

FIGS. 4a, 4b show the cross section (FIG. 4a) of a fourth embodiment of the tube liner according to the invention, in which the outer film tube is formed by a welded tube web, and the tube web in the still unwelded state (FIG. 4b); and

FIG. 5 shows a welded variant of the tube liner of FIGS. 1 to 4.

### DETAILED DESCRIPTION OF THE PREFERRED EMBODIMENTS

Identical reference signs are used for the same or functionally identical components in the following description of the figures.

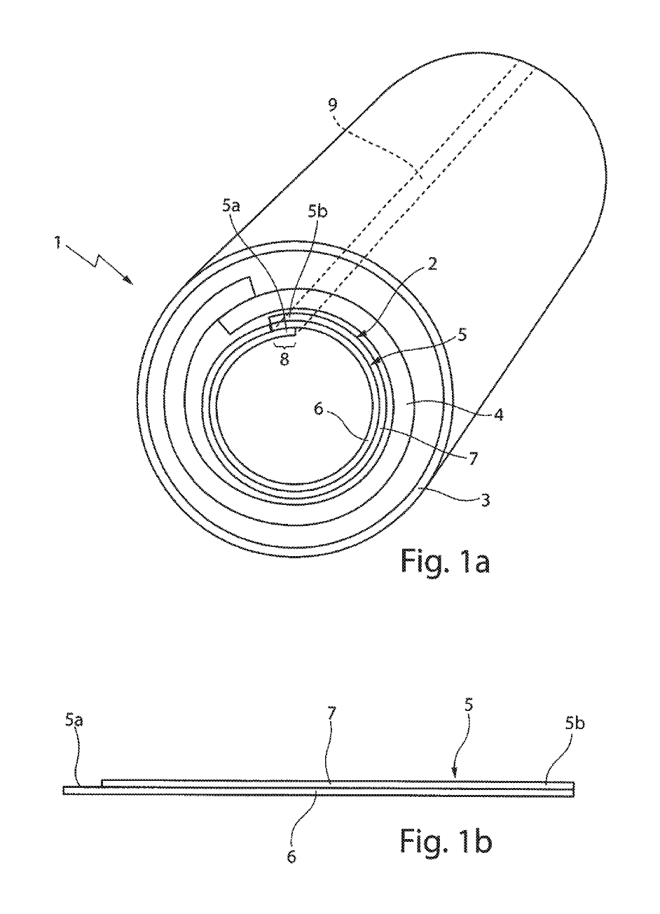

The tube liner 1 shown in FIG. 1a serves for lining an old tube to be rehabilitated, and comprises an inner film tube 2 that is transparent to light, in particular to UV light, an outer film tube 3, and an interposed flexible layer 4 of fiber material that in the circumferential direction of the tube extends in an encircling manner and that is soaked or impregnated, respectively, with a light-curing, in particular a UV light-curing, material (resin). The layer 4 of fiber material is a carrier web, the web ends of which that extend in the circumferential direction of the tube are overlapping, so as to enable the tube liner 1 to widen so as to adapt to different diameters. A plurality of layers of fiber material, each surrounding the other, may also be present instead of the one layer 4 of fiber material as shown.

As is shown in FIG. 1b, the inner film tube 2 is formed by a tube web (flat film) 5 which has a carrier film 6 and a fleece layer 7 which is laminated onto the outer side of the carrier film 6 that is facing the layer 4 of fiber material. The two web edges 5a, 5b of the tube web 5 overlap one another in the circumferential direction of the tube, and are adhesively bonded or welded to one another in their overlap region 8. The carrier film 6 and the laminated fleece layer 7 terminate so as to be mutually flush on the radially outboard web edge 5b in the overlap region 8. The radially inboard web edge 5a in the overlap region 8 is equipped without a fleece layer, that is to say in the overlap region 8 is formed singularly by the carrier film 6 which in the overlap region 8 projects beyond the fleece layer 7. The projecting carrier film 6 of the web edge 5a, and the carrier film 6 of the web edge 5b bear directly on one another in the overlap region 8, and are adhesively bonded or welded to one another in the longitudinal direction of the tube. This longitudinal adhesive bond or weld is identified by 9 in FIG. 1a. The outer side of the thus welded inner film tube 2 that is facing the layer 4 of fiber material is thus covered all-over by the fleece layer 7. Since the fleece layer 7 is also wetted with the light-curing material, the inner film tube 2 by way of the fleece layer 7 thereof is fixedly connected to the layer 4 of fiber material once the light-curing material has cured.

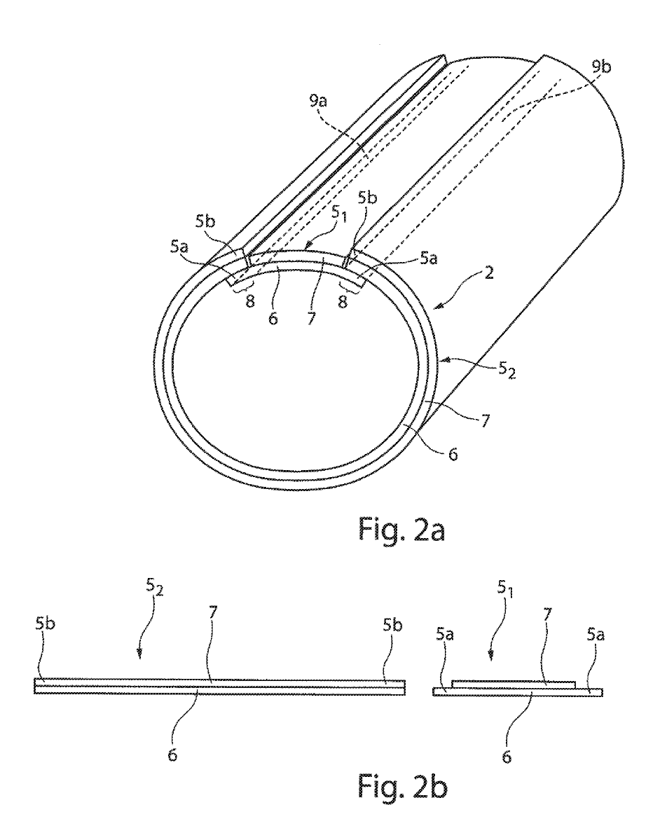

The inner film tube 2, shown in FIG. 2a, differs from the inner film tube of FIG. 1a in that the inner film tube 2 herein is formed by two tube webs 5₁, 5₂, each having a weldable carrier film 6 and a fleece layer 7 which is laminated onto that outer side of the carrier film 6 that is facing the layer 4 of fiber material. As is shown in FIG. 2b, on the two web edges 5b of the left tube web 5₂, the carrier film 6 and the laminated fleece layer 7 terminate so as to be mutually flush, while in the case of the right tube web 5₁ the two web edges 5a are formed singularly by the carrier film 6 which in each case projects beyond the fleece layer 7. The two web edges 5a, 5b of the two tube webs 5₁, 5₂ overlap one another in the circumferential direction of the tube, wherein the projecting carrier film 6 of the tube web 5₁ in the overlap region 8 is in each case disposed radially inboard. The projecting carrier film 6 of the web edges 5a and the carrier film 6 of the web edges 5b bear directly on one another in the overlap region 8, and are adhesively bonded or welded to one another in the longitudinal direction of the tube. These longitudinal adhesive bonds or welds are identified by 9a, 9b in FIG. 2a. The outer side of the thus welded inner film tube 2 that is facing the layer 4 of fiber material is thus covered all-over by the non-woven layer 7.

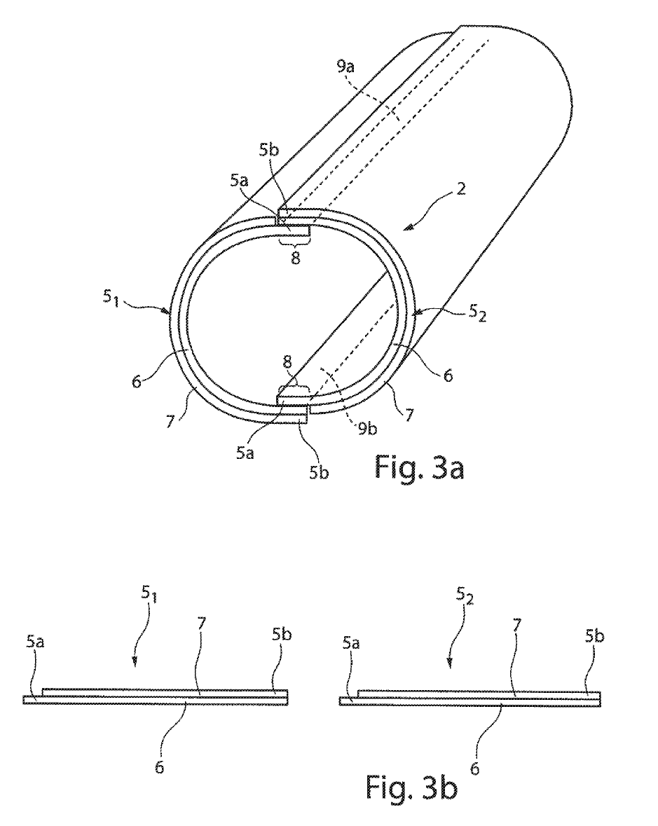

The inner film tube 2, shown in FIG. 3a, differs from the inner film tube of FIG. 2a in that herein, as is shown in FIG. 3b, the carrier film 6 of the two tube webs 5₁, 5₂ in each case projects beyond the fleece layer 7 on the one web edge 5a, and on the other web edge 5b terminates so as to be flush with the fleece layer 7. The web edges 5a, 5b of the two tube webs 5₁, 5₂ overlap one another in the circumferential direction of the tube, wherein the projecting carrier films 6 of the tube webs 5₁, 5₂ in the overlap region 8 are in each case disposed radially inboard. The projecting carrier films 6 of the web edges 5a and the carrier films 6 of the web edges 5b bear directly on one another in the overlap region 8, and are adhesively bonded or welded to one another in the longitudinal direction of the tube. These longitudinal adhesive bonds or welds are identified by 9a, 9b in FIG. 3a. The outer side of the thus welded inner film tube 2 that is facing the layer 4 of fiber material is thus covered all-over by the fleece layer 7.

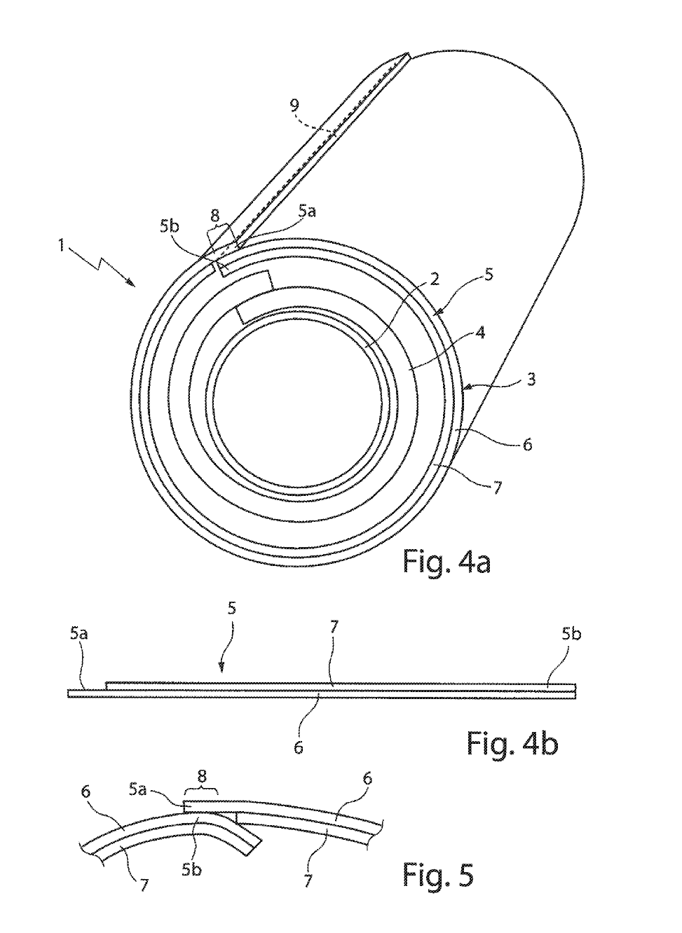

The tube liner 1, shown in FIG. 4a, differs from the tube liner of Fig. 1a in that herein the outer film tube 3 is formed by a tube web 5 that has a carrier film 6 and a fleece layer 7 which is laminated onto the inner side of the carrier film 6 that is facing the layer 4 of fiber material. The two web edges 5a, 5b of the tube web 5 overlap one another in the circumferential direction of the tube, and are adhesively bonded or welded to one another in the overlap region 8 thereof. The carrier film 6 and the laminated fleece layer 7 terminate so as to be mutually flush on the radially inboard web edge 5b in the overlap region 8. The radially outboard web edge 5a in the overlap region 8 is equipped without a fleece layer, that is to say in the overlap region 8 is formed singularly by the carrier film 6 which projects beyond the fleece layer 7 in the overlap region 8. The projecting carrier film 6 of the web edge 5a and the carrier film 6 of the web edge 5b in the overlap region 8 bear directly on one another, and are adhesively bonded or welded to one another in the longitudinal direction of the tube. This longitudinal adhesive bond or weld is identified by 9 in FIG. 4a. The inner side of the thus welded outer film tube 3 that is facing the layer 4 of fiber material is thus covered all-over by the fleece layer 7. In a manner analogous to FIGS. 2 and 3, the outer film tube 3 may also be formed by a plurality of flat films instead of by only a single flat film as is shown.

As is shown in FIG. 5, it is also possible for the web edge 5b on which the carrier film 6 and the laminated fleece layer 7 terminate so as to be mutually flush to project in the circumferential direction of the tube beyond the recessed fleece layer 7 of the other web edge 5a.

Depending on the width of the overlap region 8, the width of the web edge 5a, that is free from a fleece material, of the tube liners 1 shown in FIGS. 1 to 5 is approx. 0.3 to 10 cm. The carrier film 6 may be composed of one or a plurality of layers of identical or dissimilar materials. In the case of carrier films 6 in the form of composite films that are composed of a plurality of layers of dissimilar materials it is advantageous for at least the film surfaces that bear on one another to be composed of the same material, since the surfaces in this instance are capable of being more readily welded or adhesively bonded.

In the case of embodiments of the tube liner that are not shown, both the inner film tube 2 as well as the outer film tube 3 each are formed by at least one tube web 5 which has a carrier film 6 and a fleece layer 7 and is configured in a manner analogous to FIGS. 1 to 5.

The layer 4 of fiber material may also have other curable materials instead of light-curing resins, such as materials that are cured by cold curing, or materials that are cured by heat and that are cured by hot water or steam by which the tube liner is impinged, for example.

What is claimed is:

1. A tube liner for lining pipelines, comprising:
an inner film tube;
an outer film tube; and
an interdisposed layer of fiber material which is impregnated with a curable material, wherein the interdisposed layer of fiber material is disposed outside the inner film tube and inside the outer film tube;
wherein at least one of the two film tubes are formed by at least one tube web which comprises a carrier film and a fleece layer, wherein the fleece layer is applied to a film side of the carrier film that is facing the interdisposed layer of fiber material;
wherein a first and a second web edge of the tube web overlap one another in a circumferential direction of the tube liner and are connected to one another; and
wherein the first web edge that in the overlap region is facing away from the layer of fiber material is formed singularly by the carrier film which in the overlap region protrudes beyond the fleece layer and which is adhesively bonded or welded directly to the carrier film of the second web edge that in the overlap region is facing the layer of fiber material.

2. The tube liner of claim 1, wherein both the inner film tube as well as the outer film tube each are formed by at least one tube web which comprises a carrier film and a fleece layer, wherein the fleece layer is applied to a film side of the carrier film that is facing the interdisposed layer of fiber material, wherein a first and a second web edge of the web tube overlap one another in a circumferential direction of the tube liner and are connected to one another, and wherein the first web edge that in the overlap region is facing away from the layer of fiber material is formed singularly by the carrier film which in the overlap region protrudes beyond the fleece layer and which is adhesively bonded or welded directly to the carrier film of the second web edge that in the overlap region is facing the layer of fiber material.

3. The tube liner of claim 1, wherein the carrier film and the fleece layer terminate so as to be mutually flush on the second web edge that is facing the layer of fiber material in the overlap region.

4. The tube liner of claim 1, wherein the at least one of the two film tubes are formed by at least two tube webs.

5. The tube liner of claim 4, wherein the at least two tube webs each have a flush web edge that is fleece-laminated, and a projecting carrier film edge.

6. The tube liner of claim 4, wherein the first tube web has two flush web edges that are fleece-laminated, and the second tube web has projecting carrier film edges.

7. The tube liner of claim 1, wherein the second web edge on which the carrier film and the fleece layer terminate so as to be mutually flush protrudes beyond the first web edge that is free from the fleece layer.

8. The tube liner of claim 1, wherein the carrier film is formed by a single film layer.

9. The tube liner of claim 1, wherein the carrier film is formed by a plurality of film layers.

10. The tube liner of claim 9, wherein the plurality of film layers are composed of the same material.
